(19) United States
(12) Patent Application Publication
(10) Pub. No.: US 2010/0058320 A1
(43) Pub. Date: Mar. 4, 2010

(54) Managing Distributed System Software On A Gaming System

(75) Inventors: Timothy S. Milligan, Redmond, WA (US); James William Schmidt, Plymouth, MI (US); Andrew Martin Murphy, Seattle, WA (US); Thomas Michael Soemo, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/204,697

(22) Filed: Sep. 4, 2008

(51) Int. Cl. G06F 9/44; G06F 7/06; G06F 17/30

(52) U.S. Cl. 717/173; 707/3; 707/E17.014

(57) ABSTRACT

Mechanisms for determining the coherency of a console are described herein. A manifest may be used to check the installed software components, and their versions, to determine which user experience groups are coherent based upon the installed software packages and their versions. If the console has the required software components and their versions installed according to the manifest, providing for a coherent user experience group, the console may be set to an enhanced user experience level in which the coherent user experience groups, or features, are enabled. The console may be set at various user experience levels depending upon which user experience groups are coherent. For example, if no user experience groups are coherent, the console may be set at a “core”, basic, or default user experience level.

### COPYRIGHT NOTICE AND PERMISSION

A portion of the disclosure of this document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright©2008 Microsoft Corp.

### FIELD OF TECHNOLOGY

The presently disclosed subject matter relates to the field of computing, and more particularly, to fields such as gaming, although this is merely an exemplary and non-limiting field.

### BACKGROUND

Certain types of computing devices, such as game consoles, are typically low-priced personal computers with diverse, non-volatile storage device options. A game console may contain a combination of internal and external storage devices. When viewed in comparison to other game consoles, there may be a wide variance in capacity and storage device configuration. As the software that is run on the computing device accumulates features, the increased capacity necessary to run those features may outgrow the capacity of a storage device, requiring the use of additional storage devices. In certain computing devices, such as some game consoles, the storage devices may be removable and roamable, i.e. moved from one game console to another.

### SUMMARY

A user experience may be provided to a user of a game console in which the experience level may be upgraded, or enhanced, from a basic, or core experience level. The enhanced experience level may include, but is not limited to, the ability to use various system components like avatars, whereas the core user experience may not allow the user to use the enhanced system components. These enhanced system components may require the use of more than one memory device upon which to store various system packages, or software components, that allow the console to properly provide that user experience level.

But, in a game console in which there may be more than one memory device storing system operating packages, or storage packages, there may be an occasion in which one or more of the storage packages may be stored across the more than one memory devices. Because one of the memory devices may be portable, it is possible that the memory device has stored thereon packages of one version of software and may be used in conjunction with another memory device having packages of a different version.

When this occurs, running a user experience at an enhanced user experience level may not be verified, and thus, not allowed. For example, a game console may have a permanent memory installed and a removable memory installed for use. To provide for the enhanced user experience level, it may have been determined that the system packages must at least be of a certain version. If one of the system packages are not of the version, the enhanced user experience level may not be allowed because the different versions may not have been verified to provide the enhanced user experience level.

Various mechanisms are discussed herein that provide for various user environments through upgrades in a system with removable and/or roamable storage devices. Depending upon the version of an upgrade for a particular system component, the user experience level may vary. For example, a user experience level may be a full experience level that is provided to the user if one or more system components have a first version that is a validated system configuration to run the first version. Further, in that example, a user experience level may be a limited experience if one or more system components have a second version or an invalidated system configuration.

A manifest is also described herein upon which the version for each experience may be checked against. The manifest may be downloaded as part of an upgrade package. The manifest may be a table of the groups of system software, or packages, that have been validated for a particular upgrade. Table entries may indicate a version of a package, and may comprise other information such as the location in which to find and download the package as well as the intended storage device(s) upon which the package may be stored. The manifest may be used to describe conditions, or installed packages, that may be used to determine the experience level. For example, and not by way of limitation, an enhanced user experience level may include the ability to use a movie player if the console is located in the United States. The manifest may include software packages installed that indicate that the console is located in the United States.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects shown. The following figures are included:

FIG. 1 illustrates a game console having two memory units;

FIG. 2 illustrates the use of a manifest to check for missing software packages and/or software packages having the incorrect release version;

FIG. 3 illustrates an exemplary method for verifying the coherency of the software packages when the console is operating;

FIG. 4 illustrates an exemplary method for verifying the coherency of the software packages when updating a game console;

FIG. 5 illustrates an exemplary computing device, such as a console, that can be used in conjunction with the various aspects of the present disclosure discussed with reference to FIGS. 1-4 and 6; and

FIG. 6 illustrates an exemplary networking environment for the presently disclosed subject matter discussed with reference to FIGS. 1-5.

### DETAILED DESCRIPTION

The subject matter of the various embodiments is described with specificity to meet statutory requirements. However, the description itself is not intended to limit the scope of this patent. Rather, the inventor has contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are only exemplary. The following description is illustrative and non-limiting to any one aspect.

Further, although the description following uses “enhanced” and “core” to describe a user experience level provided on the console, it should be noted that the terms are merely to denote different user experience levels having sets of features and are not intended to limit the scope of the present subject matter. For example, an enhanced user experience level may include a set of features and a core user experience may include a different set of features, some of which may or may not be included in the set of features provided in the enhanced user experience level.

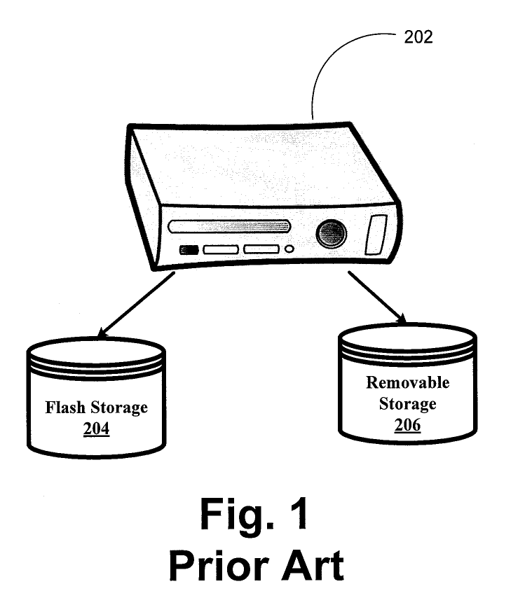

FIG. 1 illustrates an exemplary and non-limiting example of a computer system that has two memory units. Shown is game console 202 having two memory units, permanently installed flash storage 204 and removable storage 206. Flash storage 204 may store, among other things, computer executable instructions comprising the operating system of console 202. As enhanced features become available, updates may be downloaded and stored in flash storage 204 for later installation.

Removable storage 206 may be of various types, including a removable hard drive, universal serial bus (USB) memory stick or any other type of storage device, or combination of such devices, that may become available for use. As features for console 202 become more complex, it may become necessary to use some of the storage capacity of removable storage 206. For example, the use of avatars in online game playing may require a large amount of storage capacity, greater than that offered solely by flash storage 204.

Thus, in order to provide that enhanced user experience level, software packages comprising computer executable instructions may be stored on removable storage 206. These software packages may constitute a set of user experience groups. Coherency of the console may be verified if these user experience groups are installed. If the appropriate user experience group is installed, the user experience level may be set to the corresponding user experience group verified to be installed, or coherent within the console. If the user experience group is not installed, the console user experience level may be set to a different user experience level, which may be a core or basic experience level provided on the console if not user experience groups are installed.

Because removable storage 206 is removable, or roamable, there may be an occasion in which the software packages necessary to properly execute the enhanced user experience level may be missing or may be of the incorrect version, i.e. a “1.0” release rather than the correct “2.0” release. This may happen for various reasons. For example, removable storage 206 may have been recently purchased and, thus, may not have the software packages store thereon. Also, removable storage 206 may have been transferred from one console to another. If while removable storage 206 was in communication with another console and no software packages were downloaded, or the software packages were of an earlier release version, when connected to another console, the software packages may be missing or of the incorrect version.

In order to adequately assure that a console will be able to provide an enhanced experience, it may be necessary to test various software packages and their versions. After testing, a list may be generated, the list comprising the software packages and versions that a console must have installed in order to run the enhanced experience level. These packages and their version numbers, and the combinations of each, constitute a coherent system. This list, which may be termed a manifest, is used by the console to determine if the console is configured in a manner that has been tested.

To reach its full utility, the manifest may describe all or some of the packages of a particular product or feature, even if the particular features may be appropriate for one type of system, such as a game console, or one system configured in one manner, such as a console located in the United States. The condition of the system, the runtime conditions, may be expressed in the manifest. In one example, a manifest list only packages that meet the runtime conditions that are permitted on a particular console. Having the conditions expressed in the manifest explicitly identifies the combinations that are tested as stable. Therefore, a certain level of quality control may be applied to the combinations. If one or more user packages are not present, thus lacking the packages necessary to form certain user experience combinations, or groups, the console may prohibit the unsupported, or incoherent, combination.

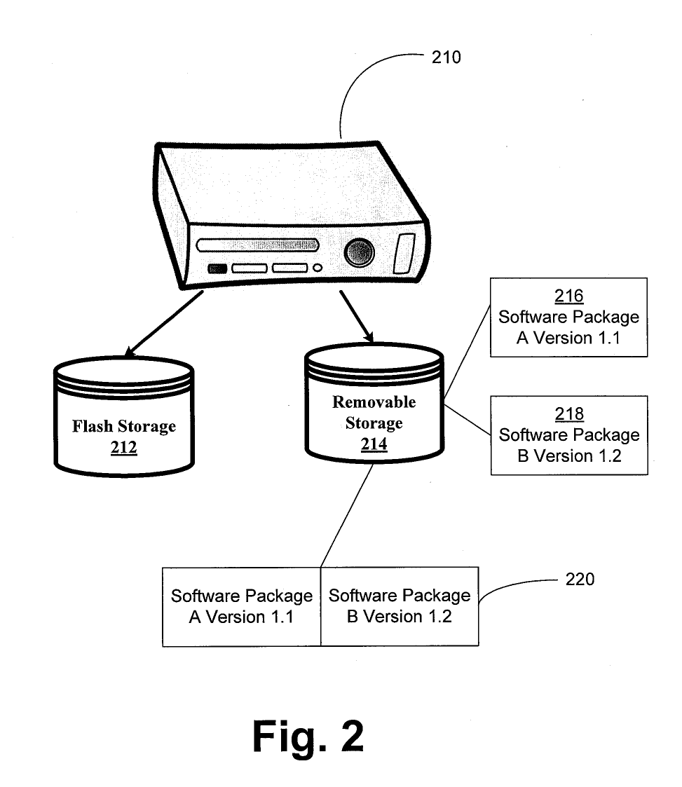

FIG. 2 is an exemplary and non-limiting example of the use of a manifest to check for coherency of a system. Console 210 has removable storage 214 and flash storage 212. In this example, stored on removable storage 214, and installed on console 210, are software packages 216 and 218. Software package 216 is software package “A” and has version 1.1 and software package 218 is software package “B” and has version 1.2. Software packages 216 and 218 have been downloaded, and installed, in order to run an enhanced feature of console 202, for example, the use of avatars in an online gaming service.

To allow console 210 to run the enhanced user experience level, also stored in removable storage is manifest 220. Manifest 220 comprises a list of software packages and their respective versions required to permit console 210 to provide the enhanced user experience level. In this example, in order to provide the enhanced user experience level, the console must have software package “A” version 1.1 and software package “B” version 1.2. Console 210, prior to allowing the enhanced user experience level, will access manifest 220 and check to see if the required software packages are installed on console 210.

If the packages are not installed, or the version is different, console 210 may use manifest 220 to get a list of the missing software packages and/or the correct versions of previously installed software packages. When a console software update is invoked, the missing software packages or the correct versions of the software packages may be retrieved. Further, as the enhanced user experience software packages change, the manifest may be updated.

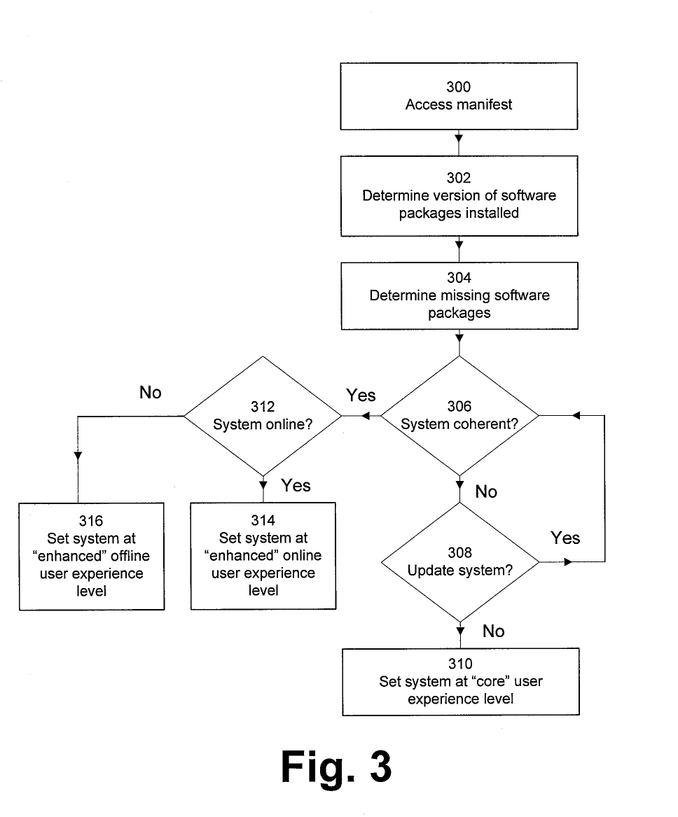

FIG. 3 is an exemplary method in which a manifest may be used to check a console configuration for coherency. In order to allow an enhanced user experience, a console may be required to check that the relevant software packages necessary to run the enhanced user experience level, as well as their release version, are installed on the console. The console accesses 300 the manifest and console determines 302 the version of software packages installed. The console determines 304 the missing software packages according to the manifest. The. It should be noted that the steps may be performed simultaneous or in a serial manner, and may be performed in various configurations. Further, it should be noted that other computing resources, such as a remote server, may also determine various aspects, such as the version of the software installed.

Once the versions of the software packages are determined as well as the missing software packages, the console determines 306 whether or not the console software is coherent by comparing the information to the related information in the manifest. For example, as described in FIG. 2, above, a manifest may indicate that in order for a console to be coherent, there must be software package “A” of one version and software package “B” of another version. If the versions are incorrect or either one of the software packages are missing, the system is not coherent.

At this point, the console may be configured to set 310 the user experience level at a “core”, or second, level if the system is determined to not be coherent. Or, the console may be configured to provide a means for updating the console in an attempt to reconfigure the console to be coherent. If the system is updated 308, after the update, the console re-verifies 306. If the console is not coherent and there are no updates available, the console is set 310 at the “core” user experience level.

In some configurations, there may be various levels of an enhanced user experience level. For example, there may be additional features available to the user if the console is connected to an online gaming service through an internet connection. For example, the console may be configured to provide a voice chat service to other users of other consoles if the console is connected to the online gaming service. Thus, a determination 312 may be made to check if the console is online and connected to the online gaming service. If the console is connected, the console may be set 314 at an enhanced, or third, online user experience level. If the console is not connected, the console may be set 316 at an enhanced, or first, offline user experience level.

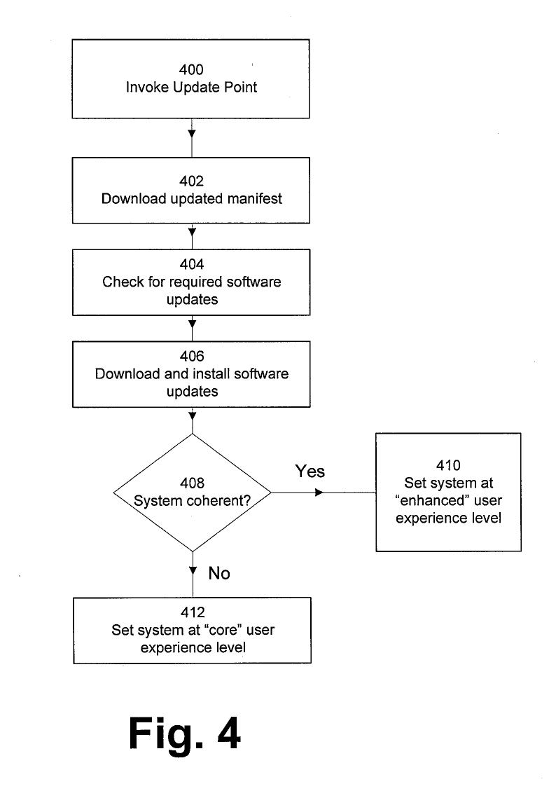

If the console is set at a core user experience level, the console may be configured to attempt an update to reconfigure the console to be coherent. FIG. 4 is an exemplary and non-limiting method in which the console may be updated. An update point is invoked at 400. This update point may vary, but may include, without being limited to, the use of a disc comprising computer executable instructions for running a game or the connection of a console to an online service, such as an online gaming service. For example, some game compact discs may have thereon instructions for updating the console to provide enhanced feature relating to the game. In another example, if a user connects the console to an online gaming service, as part of the access to the online gaming service, it may be required that the console receive and install updates relating to the enhanced experience level.

Once the update point has been invoked, an updated manifest may be downloaded 402 to provide for the ability to check the console for coherency after the updates. It should be noted that an updated manifest may also include an original manifest if a manifest has not been previously stored on the console. A check may be made to determine 404 if there are any software updates required, and if there are updates required, the updates will be downloaded and installed 406 on the console. If the console is determined 408 to be coherent, the console may be set 410 to an enhanced user experience level. If the console is determined to not be coherent, the console may be set 412 to a core user experience level.

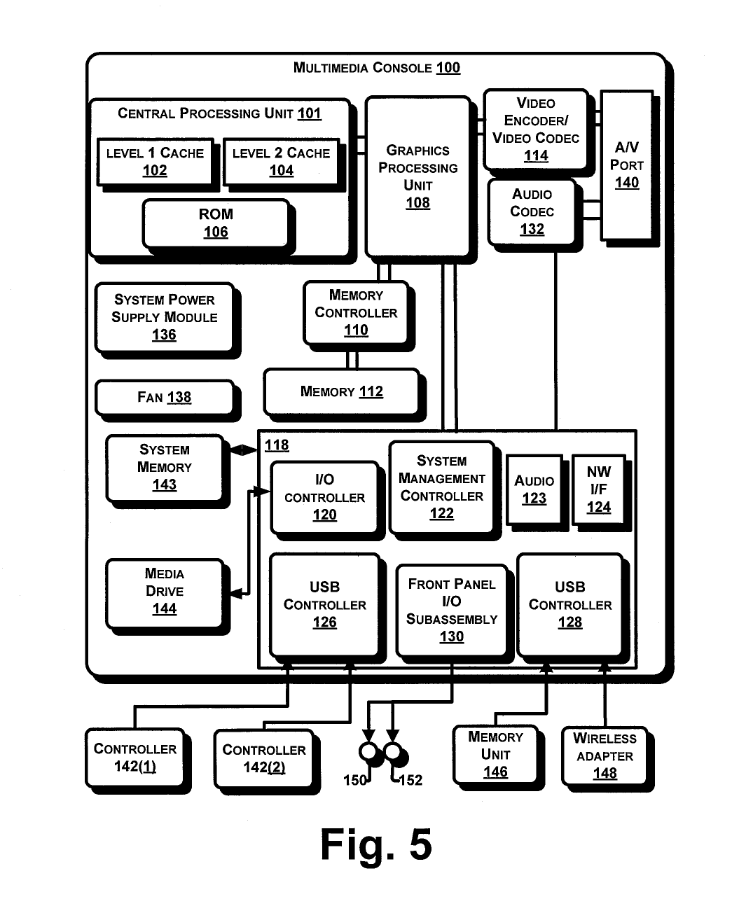

The above discussed computing devices and accessories can be embodied as gaming consoles, music players, personal computers, controllers, remote control devices and other such devices having different, similar, or the same platforms. Referring to FIG. 5, a block diagram shows an exemplary multimedia console that can be used in conjunction with the present subject matter.

This console, which may include a game oriented console or a PC, can comprise, for example, digital audio processing functionality. Specifically, in FIG. 5, a multimedia console 100 is shown, with a central processing unit (CPU) 101 having a level 1 (L1) cache 102, a level 2 (L2) cache 104, and a flash ROM (Read-only Memory) 106. The level 1 cache 102 and level 2 cache 104 can temporarily store data and hence reduce the number of memory access cycles, thereby improving processing speed and throughput. The flash ROM 106 can store executable code that is loaded during an initial phase of a boot process when the multimedia console 100 is powered. Alternatively, the executable code that is loaded during the initial boot phase can be stored in a flash memory device (not shown). Further, ROM 106 can be located separately from the CPU 101. These memory devices can cache parts or the entirety of the above mentioned applications, programs, applets, managed code, and so on. Moreover, these memory devices can store sensitive and non-sensitive information on a memory unit-by-memory unit basis, as was discussed above. Any of such information can be used at least in part to provide the present subject matter.

A graphics processing unit (GPU) 108 and a video encoder/video codec (coder/decoder) 114 can form a video processing pipeline for high speed and high resolution graphics processing. Data can be carried from the graphics processing unit 108 to the video encoder/video codec 114 via a bus. The video processing pipeline can output data to an A/V (audio/video) port 140 for transmission to a television or other display. A memory controller 110 can be connected to the GPU 108 and CPU 101 to facilitate processor access to various types of memory 112, such as, but not limited to, a RAM (Random Access Memory). Thus, various types of information, whether sensitive or not, or even parts of various types of information, can be stored in the various types of memories discussed above, depending on the need.

The multimedia console 100 can include an I/O controller 120, a system management controller 122, an audio processing unit 123, a network interface controller 124, a first USB host controller 126, a second USB controller 128 and a front panel I/O subassembly 130 that can be preferably implemented on a module 118. The USB controllers 126 and 128 can serve as hosts for peripheral controllers 142(1)-142(2), a wireless adapter 148, and an external memory unit 146 (e.g., flash memory, external CD/DVD ROM drive, removable media, etc.). Moreover, the network interface 124 and/or wireless adapter 148 can provide access to a network (e.g., the Internet, home network, etc.) and can be any of a wide variety of various wired or wireless interface components including an Ethernet card, a modem, a Bluetooth module, a cable modem, and the like. For example, network interface 124 may be used to connect console 100 with the online gaming service discussed above.

System memory 143 can be provided to store application data that is loaded during the boot process. A media drive 144 can be provided and can comprise a DVD/CD drive, hard drive, or other removable media drive, etc. The media drive 144 can be internal or external to the multimedia console 100. Application data can be accessed via the media drive 144 for execution, playback, etc. by the multimedia console 100. The media drive 144 can be connected to the I/O controller 120 via a bus, such as a Serial ATA bus or other high speed connection (e.g., IEEE 1394). Additional to such application data, other information can be stored on the console 100 that will aid in the communication between peripheral / accessory device controllers and the console 100 itself.

The system management controller 122 can provide a variety of service functions to assure the availability of the multimedia console 100. The audio processing unit 123 and an audio codec 132 can form a corresponding audio processing pipeline with high fidelity, 3D, surround, and stereo audio processing according to aspects of the presently disclosed subject matter above. Audio data can be carried between the audio processing unit 123 and the audio codec 132 via a communication link. The audio processing pipeline can output data to the A/V port 140 for reproduction by an external audio player or device having audio capabilities.

The front panel I/O subassembly 130 can support the functionality of the power button 150 and the eject button 152, as well as any LEDs (light emitting diodes) or other indicators exposed on the outer surface of the multimedia console 100. A system power supply module 136 can provide power to the components of the multimedia console 100. A fan 138 can cool the circuitry within the multimedia console 100.

The CPU 101, GPU 108, memory controller 110, and various other components within the multimedia console 100 can be interconnected via one or more buses, including serial and parallel buses, a memory bus, a peripheral bus, and a processor or local bus using any of a variety of bus architectures.

When the multimedia console 100 is powered on or rebooted, application data can be loaded from the system memory 143 into memory 112 and/or caches 102, 104 and executed on the CPU 101. Such application data can include some of the online derived data, including the enhanced user experience level software packages discussed above. The application can also present a graphical user interface that provides a consistent user experience when navigating to different media types available on the multimedia console 1 00. In operation, applications and/or other media contained within the media drive 144 can be launched or played from the media drive 144 to provide additional functionalities to the multimedia console 100. And, such media, including game titles can be the basis for providing the enhanced user experience levels.

The multimedia console 100 can be operated as a standalone system by simply connecting the system to a television or other display. In this standalone mode, the multimedia console 100 can allow one or more users to interact with the system, watch movies, listen to music, and the like. However, with the integration of broadband connectivity made available through the network interface 124 or the wireless adapter 148, the multimedia console 100 can further be operated as a participant in a larger network community of computing devices. As such a participant, it can interact with computing devices, whether PCs or servers, and receive information that can be eventually stored.

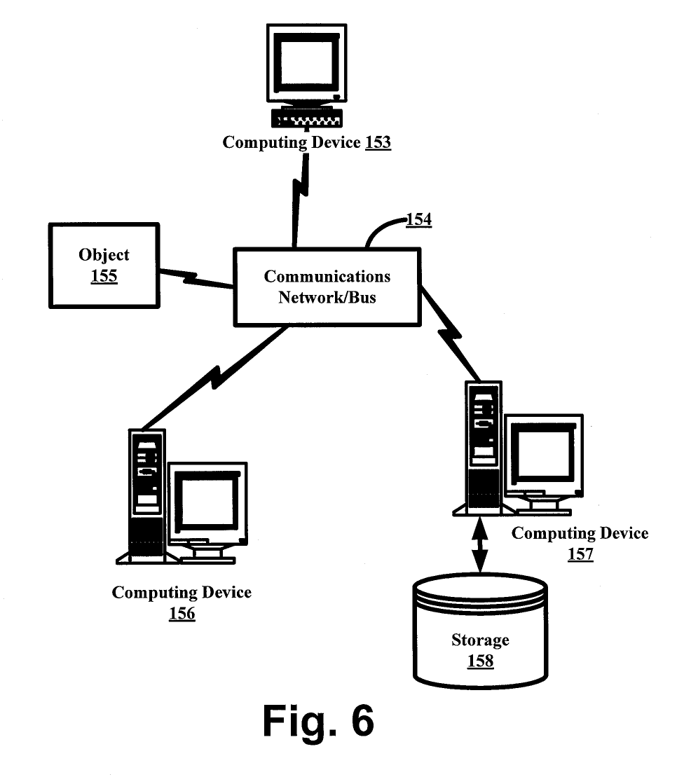

Next, FIG. 6 illustrates an exemplary networking environment for subject matter discussed with reference to FIGS. 1-5. The above discussed console 100, represented in FIG. 6 as computing device 153, can correspond to any one of the aforementioned computing devices, or it can be distributed over such devices. It can interact with various other objects 155 and storage devices 158 via a communications network/bus 154, where such objects 155 and devices 158 can correspond to other computing devices (whether hardware, firmware, or software), such as devices 156 and 157.

Finally, it should also be noted that the various techniques described herein can be implemented in connection with hardware or software or, where appropriate, with a combination of both. Thus, the methods and apparatus of the presently disclosed subject matter, or certain aspects or portions thereof, can take the form of program code (i.e., instructions) embodied in tangible storage media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device can generally include a processor, a storage medium readable by the processor (including volatile and non-volatile memory and/or storage elements), at least one input device, and at least one output device. One or more programs that can utilize the creation and/or implementation of domain-specific programming models aspects of the present invention, e.g., through the use of a data processing application programming interface (API) or the like, are preferably implemented in a high level procedural or object oriented programming language to communicate with a computer system. However, the program(s) can be implemented in assembly or machine language, if desired. In any case, the language can be a compiled or interpreted language, and combined.

Finally, while the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods, systems, and computer readable media were described configured for determining the coherency of a console. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A method for determining a user experience level on a console, comprising:
determining an update version of a plurality of storage packages on a plurality of storage devices;
accessing a manifest having a set of user experience groups;
checking the update version of the plurality of storage packages against the manifest;
determining which user experience groups are coherent based upon the plurality of storage packages; and
setting the console at a first user experience level by enabling the user experience groups that are verified to be coherent.

2. The method of claim 1, further comprising setting the user experience level at a second user experience level if the user experience groups are not verified to be coherent.

3. The method of claim 1, wherein accessing the manifest further comprises:
invoking an update point;
downloading a flash update; and
obtaining a manifest update.

4. The method of claim 3, further comprising cleansing the console with the updated manifest.

5. The method of claim 4, further comprising determining a missing storage package.

6. The method of claim 5, further comprising downloading the missing storage package and updating the console with the missing storage package.

7. The method of claim 1, wherein the set of user experience groups comprises enhanced features.

8. The method of claim 7, wherein the enhanced features are avatars, a movie player, or a voice chat service.

9. The method of claim 1, further comprising finding a storage target and storing the manifest.

10. The method of claim 1, further comprising setting the user experience level at a third level if the console is in communication with an online service through an Internet connection.

11. A console configured to provide a plurality of user experiences, comprising:
an input module configured to receive a flash package, a plurality of storage packages comprising a plurality of user experience groups, and a manifest;
a plurality of memory modules configured to store the flash package, the plurality of storage packages, and the manifest; and
a processing module configured to install the flash package and to install the plurality of storage packages, wherein the processing module sets the console at a first user experience level by enabling the plurality of user experience groups that are verified to be coherent according to the manifest.

12. The console of claim 11, wherein the processing module is further configured to check the manifest against the installed plurality of storage packages to determine if there is a missing package.

13. The console of claim 12, wherein the console is configured to download the missing package and wherein the processing module is configured to install the missing package.

14. The console of claim 11, wherein the processing module is configured to set the user experience level at a second level if the plurality of user experience groups are not verified to be coherent according to the manifest.

15. The console of claim 11, wherein the set of user experience groups comprises enhanced features, wherein the enhanced features comprise avatars, a movie player, and a voice chat service.

16. A computer-readable storage medium storing thereon computer executable instructions for determining a user experience level of a console, comprising:
an instruction for determining a version of each of a plurality of storage packages installed on the console;
an instruction that checks the version of each of the plurality of storage packages installed on the console against a manifest, wherein the manifest comprises a version of each of the plurality of storage packages that provides for a first user experience level; and
an instruction that sets the console at the first user experience level if the version of each of the plurality of storage packages is coherent according to the manifest.

17. The computer-readable storage medium of claim 16, further comprising an instruction that sets the console at a second user experience level if the console is connected to an online console service.

18. The computer-readable storage medium of claim 16, further comprising an instruction that sets the console at a third user experience level if the version of each of the plurality of storage packages are not coherent according to the manifest.

19. The computer-readable storage medium of claim 16, further comprising:
an instruction to determine a storage package that is missing or a storage package that has an incorrect version according to the manifest;
an instruction to download the missing storage package or an instruction to download an update to the package with the incorrect version; and
an instruction to install the missing storage package or update the package with the incorrect version.

20. The computer-readable storage medium of claim 16, further comprising setting the user experience level at a third level if the system is coherent and connected to an online service.
